(19) United States
(12) Patent Application Publication
(10) Pub. No.: US 2023/0022930 A1
(43) Pub. Date: Jan. 26, 2023

(54) WALKING ASSIST DEVICE, CONTROL METHOD, AND STORAGE MEDIUM

(71) Applicant: TOYOTA JIDOSHA KABUSHIKI KAISHA, Toyota-shi (JP)

(72) Inventor: Uori KOIKE, Toyota-shi (JP)

(73) Assignee: TOYOTA JIDOSHA KABUSHIKI KAISHA, Toyota-shi (JP)

(21) Appl. No.: 17/747,205

(22) Filed: May 18, 2022

(30) Foreign Application Priority Data
Jul. 26, 2021 (JP) 2021-121449

(51) Int. Cl. A61H 1/02; A61H 3/00

(52) U.S. Cl. CPC A61H 1/024; A61H 3/00; A61H 2230/62; A61H 2201/5069; A61H 2201/5064; A61H 2201/165; A61H 2201/164; A61H 2003/007

(57) ABSTRACT

A walking assist device applies resistance force to a movement of a knee joint of a user according to a walking state of the user to assist a walking motion of the user. The walking assist device includes an auxiliary control unit that decreases the resistance force applied to the movement of the knee joint of the user when the walking state of the user transitions from a standing phase to a swinging phase, and a knee collapse sensing unit that senses a knee collapse by detecting that the knee joint of the user is located forward of a waist portion of the user during the standing phase. When the knee collapse sensing unit senses the knee collapse, the auxiliary force control unit reduces a degree of a decrease in the resistance force or stops the decrease in the resistance force.

### CROSS-REFERENCE TO RELATED APPLICATION

This application claims priority to Japanese Patent Application No. 2021-121449 filed on Jul. 26, 2021, incorporated herein by reference in its entirety.

### BACKGROUND

### 1. Technical Field

The present disclosure relates to a walking assist device, a control method, and a storage medium, and more particularly to a walking assist device, a control method, and a storage medium that apply resistance force to the surrounding area of the knee of a user.

### 2. Description of Related Art

A body motion detection device disclosed in Japanese Patent No. 5927552 (JP 5927552 B) uses two displacement sensors arranged on the respective front surface of the upper leg and the front surface of the lower leg to distinguish each phase of a standing phase and a swinging phase in a walking motion of a user to further detailed sections. Such a body motion detection device can be used by being attached to a walking assist device. Such a walking assist device can increase or decrease the resistance force applied to the surrounding area of the knee of the user based on the distinguished sections.

### SUMMARY

The inventors and the like of the present application have discovered the following issues.

The knee of a user may collapse while the user is walking. When the knee collapses, such a body motion detection device may erroneously distinguish each phase of the standing phase and the swinging phase in the walking motion of the user. Therefore, such a walking assist device may not be able to appropriately increase or decrease the resistance force applied to the surrounding area of the knee of the user, and may not be able to appropriately assist the walking motion of the user.

In view of the above issues, an object of the present disclosure is to provide a walking assist device, a control method, and a storage medium that appropriately assist the walking motion of the user by sensing a knee collapse in the walking motion.

A walking assist device according to the present disclosure is a walking assist device that applies resistance force to a movement of a knee joint of a user according to a walking state of the user to assist a walking motion of the user. The walking assist device includes an auxiliary force control unit that decreases the resistance force applied to the movement of the knee joint of the user when determination is made that the walking state of the user transitions from a standing phase to a swinging phase, and a knee collapse sensing unit that senses a knee collapse by detecting that the knee joint of the user is located forward of a waist portion of the user during the standing phase. When the knee collapse sensing unit senses the knee collapse, the auxiliary force control unit reduces a degree of a decrease in the resistance force or stops the decrease in the resistance force.

According to such a configuration, even when the knee collapses, the degree of the decrease in the resistance force applied to the movement of the knee joint is reduced, or the decrease in the resistance force applied to the movement of the knee joint is stopped. Therefore, it is possible to apply the sufficient resistance force to the movement of the knee joint of the user of which the knee collapses. Therefore, in the walking motion of the user, it is possible to sense the knee collapse and appropriately assist the walking motion of the user.

Alternatively, the walking assist device may further include an upper leg posture angle acquisition unit that acquires an upper leg posture angle made by a longitudinal axis of an upper leg of the user and a vertical line, and the knee collapse sensing unit may determine that the knee joint of the user is located forward of the waist portion of the user during the standing phase based on the acquired upper leg posture angle.

According to such a configuration, the knee collapse can be sensed by using the upper leg posture angle.

Alternatively, the walking assist device may further include a knee position sensor that is able to detect a position of the waist portion with respect to the knee joint of the user, and the knee collapse sensing unit may determine that the knee joint of the user is located forward of the waist portion of the user during the standing phase using the knee position sensor.

According to such a configuration, the knee collapse can be sensed by using the position of the waist portion with respect to the knee joint of the user.

A control method of a walking assist device according to the present disclosure is a control method executed in the walking assist device that applies resistance force to a movement of a knee joint of a user according to a walking state of the user to assist a walking motion of the user. The control method includes a step of decreasing the resistance force applied to the movement of the knee joint of the user when determination is made that the walking state of the user transitions from a standing phase to a swinging phase, and a step of sensing a knee collapse by detecting that the knee joint of the user is located forward of a waist portion of the user during the standing phase.

When the knee collapse is sensed in the step of sensing the knee collapse, a degree of a decrease in the resistance force is reduced or the decrease in the resistance force is stopped in the step of decreasing the resistance force.

According to such a configuration, even when the knee collapses, the degree of the decrease in the resistance force applied to the movement of the knee joint is reduced, or the decrease in the resistance force applied to the movement of the knee joint is stopped. Therefore, it is possible to apply the sufficient resistance force to the movement of the knee joint of the user of which the knee collapses. Therefore, in the walking motion of the user, it is possible to sense the knee collapse and appropriately assist the walking motion of the user.

A storage medium storing a control program of a walking assist device according to the present disclosure is a storage medium storing a control program executed by a computer that operates as an arithmetic device in the walking assist device that applies resistance force to a movement of a knee joint of a user according to a walking state of the user to assist a walking motion of the user. The control program causes the computer to execute

a step of decreasing the resistance force applied to the movement of the knee joint of the user when determination is made that the walking state of the user transitions from a standing phase to a swinging phase, and
a step of sensing a knee collapse by detecting that the knee joint of the user is located forward of a waist portion of the user during the standing phase.

When the knee collapse is sensed in the step of sensing the knee collapse, the control program causes the computer to execute reducing a degree of a decrease in the resistance force or stopping the decrease in the resistance force in the step of decreasing the resistance force.

According to such a configuration, even when the knee collapses, the degree of the decrease in the resistance force applied to the movement of the knee joint is reduced, or the decrease in the resistance force applied to the movement of the knee joint is stopped. Therefore, it is possible to apply the sufficient resistance force to the movement of the knee joint of the user of which the knee collapses. Therefore, in the walking motion of the user, it is possible to sense the knee collapse and appropriately assist the walking motion of the user.

According to the present disclosure, in the walking motion of the user, it is possible to sense the knee collapse and appropriately assist the walking motion of the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a walking assist device according to a first embodiment;

FIG. 2 is a block diagram showing a control configuration of the walking assist device according to the first embodiment;

FIG. 3 is a schematic diagram showing an upper leg posture angle θt and a lower leg posture angle θs;

FIG. 4 is a schematic diagram showing a standing phase and a swinging phase in an example of a walking motion of a user;

FIG. 5 is a schematic diagram showing a knee collapse state and a swinging transition state;

FIG. 6 is a flowchart of a control method of the walking assist device according to the first embodiment;

FIG. 7 is a graph showing a change in the lower leg posture angle θs in an example of the walking motion of the user; and

FIG. 8 is a diagram showing an example of a hardware configuration included in the walking assist device.

### DETAILED DESCRIPTION OF EMBODIMENTS

Hereinafter, specific embodiments to which the present disclosure is applied will be described in detail with reference to the drawings. However, the present disclosure is not limited to the following embodiments. Further, in order to clarify the explanation, the following description and drawings are simplified as appropriate.

### First Embodiment

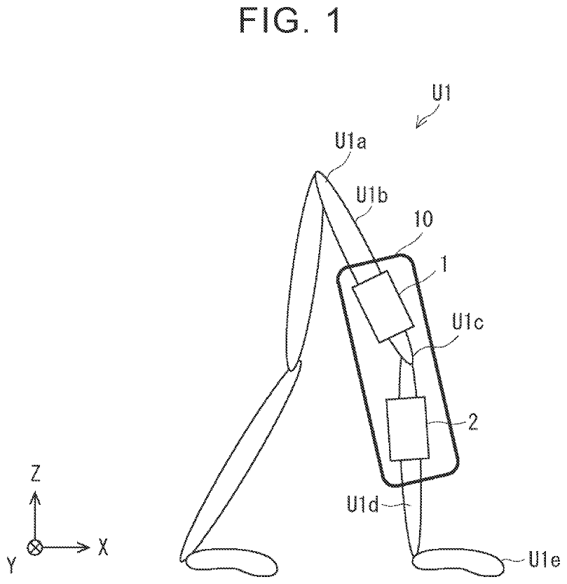

A first embodiment will be described with reference to FIGS. 1 to 5. As a matter of course, the right-handed XYZ coordinates shown in FIG. 1 and other figures are shown for convenience of describing the positional relationship of the components. Usually, the Z-axis positive direction is a vertically upward direction, and the XY plane is a horizontal plane, which is common between the drawings.

As shown in FIG. 1, a walking assist device 10 includes an upper leg side link 1 and a lower leg side link 2. The walking assist device 10 is used by being attached to the leg of a user U1. The upper leg side link 1 is detachably attached to an upper leg U1b of the user U1. The lower leg side link 2 is detachably attached to a lower leg U1d of the user U1. The upper leg side link 1 and the lower leg side link 2 rotate around a knee joint U1c of the user U1. The user U1 is often a person who has difficulty in freely moving the knee joint. The user U1 often attaches the walking assist device 10 to the leg of the user U1 and performs a walking motion as training for the purpose of recovering the movement function of the knee joint. The walking assist device 10 applies resistance force to the movement of the knee joint of the user U1 according to the walking state of the user U1 to assist the walking motion of the user U1.

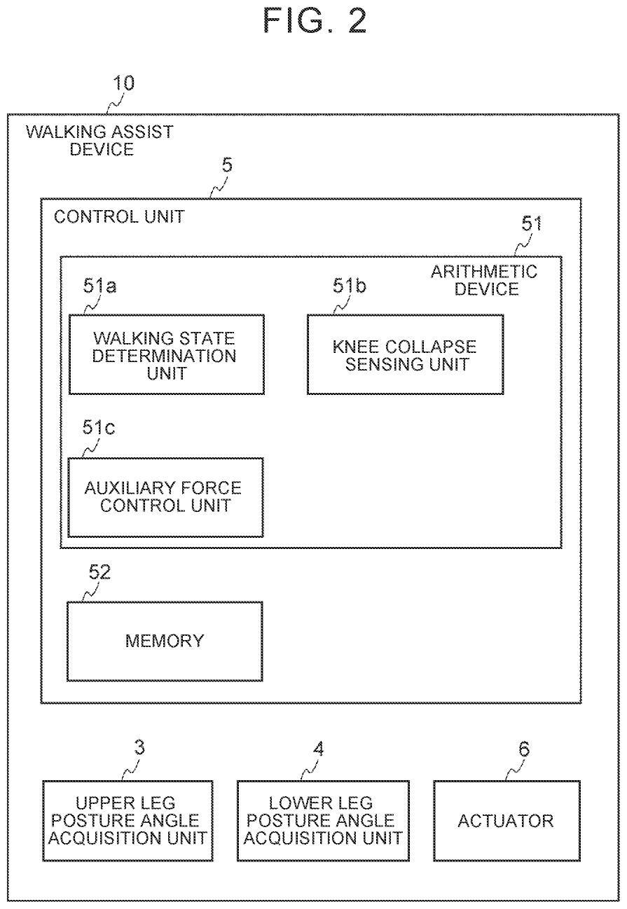

As shown in FIG. 2, the walking assist device 10 includes an upper leg posture angle acquisition unit 3, a lower leg posture angle acquisition unit 4, a control unit 5, and an actuator 6.

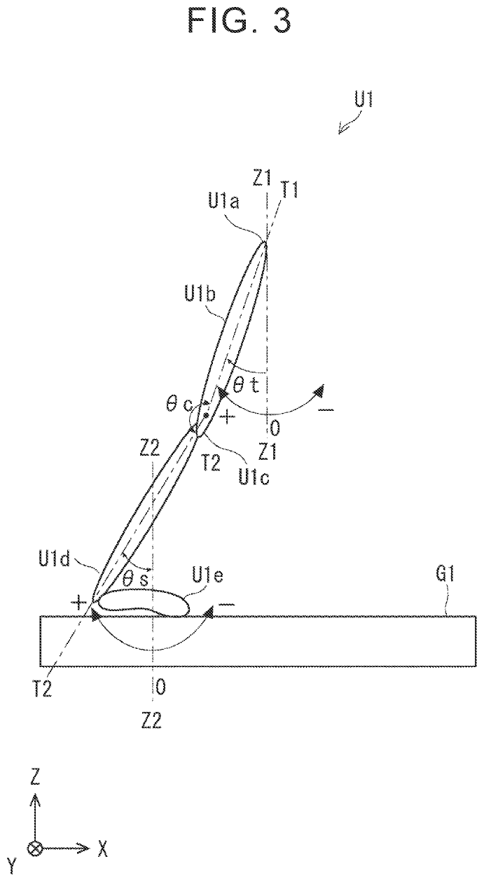

The upper leg posture angle acquisition unit 3 may be any unit that detects the upper leg posture angle θt shown in FIG. 3, and is, for example, an upper leg posture angle sensor. The user U1 shown in FIG. 3 is in a state where a foot U1e is placed on a walking surface G1. The upper leg posture angle t is an angle made by intersecting a vertical line Z1 and a longitudinal axis T1 of the upper leg U1b. The vertical line Z1 is a straight line extending in a direction of gravity (here, the Z-axis direction). When the knee joint U1c of the user U1 is located forward of a waist portion U1a of the user U1 (here, the positive side in the X-axis direction), the upper leg posture angle t is a negative value. When the knee joint U1c of the user U1 is located rearward of the waist portion U1a (here, the negative side in the X-axis direction), the upper leg posture angle θt is a positive value. The upper leg posture angle acquisition unit 3 may be attached to the upper leg side link 1 or the lower leg side link 2. The upper leg posture angle acquisition unit 3 may obtain the position of the waist portion U1a of the user U1 with respect to the knee joint U1c of the user U1 using a sensor capable of detecting thereof. The upper leg posture angle acquisition unit 3 is, for example, an inertial measurement unit (IMU) or the like.

The lower leg posture angle acquisition unit 4 may be any unit that detects the lower leg posture angle θs shown in FIG. 3, and is, for example, an lower leg posture angle sensor. The lower leg posture angle θs is an angle made by intersecting a vertical line Z2 and a longitudinal axis T2 of the lower leg U1d. The vertical line Z2 is a straight line extending in a direction of gravity (here, the Z-axis direction), as in the vertical line Z1. The lower leg posture angle acquisition unit 4 may be attached to the upper leg side link 1 or the lower leg side link 2. When the knee joint U1c of the user U1 is located forward of the waist portion U1a of the user U1 (here, the positive side in the X-axis direction), the lower leg posture angle θs is a negative value. When the knee joint U1c of the user U1 is located rearward of the waist portion U1a (here, the negative side in the X-axis direction), the lower leg posture angle θs is a positive value.

The control unit 5 acquires the upper leg posture angle 9t, the lower leg posture angle θs, and the like, and transmits a control signal to the actuator 6. The control unit 5 includes an arithmetic device 51 and a memory 52.

The arithmetic device 51 includes a walking state determination unit 51a, a knee collapse sensing unit 51b, and an auxiliary force control unit 51c.

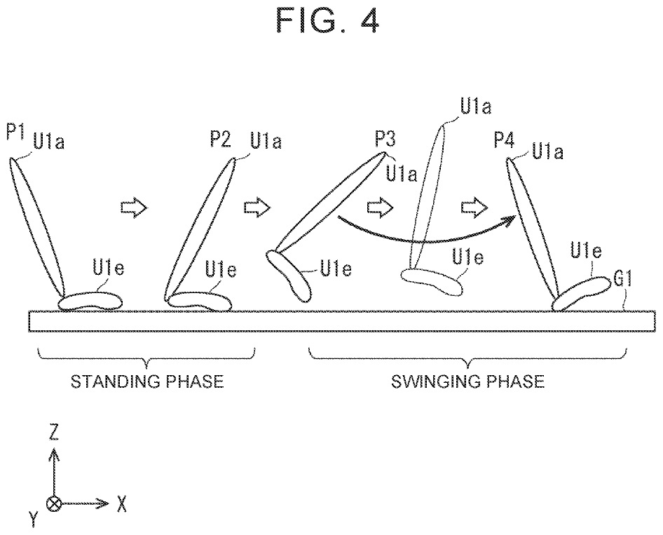

The walking state determination unit 51a estimates the walking state of the user U1 based on the lower leg posture angle θs and the like. As shown in FIG. 4, the walking state of the user U1 includes the standing phase and the swinging phase, and the standing phase and the swinging phase are alternately repeated during the walking motion. Specifically, the walking state determination unit 51a estimates the walking state of the user U1 by comparing the lower leg posture angle θs with a lower leg swinging determination threshold value ThSw_s and a lower leg standing determination threshold value ThSt_s from moment to moment. More specifically, when the lower leg posture angle θs exceeds the lower leg swinging determination threshold value ThSw_s, the walking state determination unit 51a determines that the walking state has transitioned from the standing phase to the swinging phase. The lower leg swinging determination threshold value ThSw_s and the lower leg standing determination threshold value ThSt_s can be set as appropriate, and may be set according to the gait of the user U1, for example. When the lower leg posture angle θs is below the lower leg standing determination threshold value ThSt_s, the walking state determination unit 51a determines that the walking state has transitioned from the standing phase to the swinging phase.

When the walking state is in the standing phase, the knee collapse sensing unit 51b senses whether the state is in the knee collapse state based on the upper leg posture angle θt.

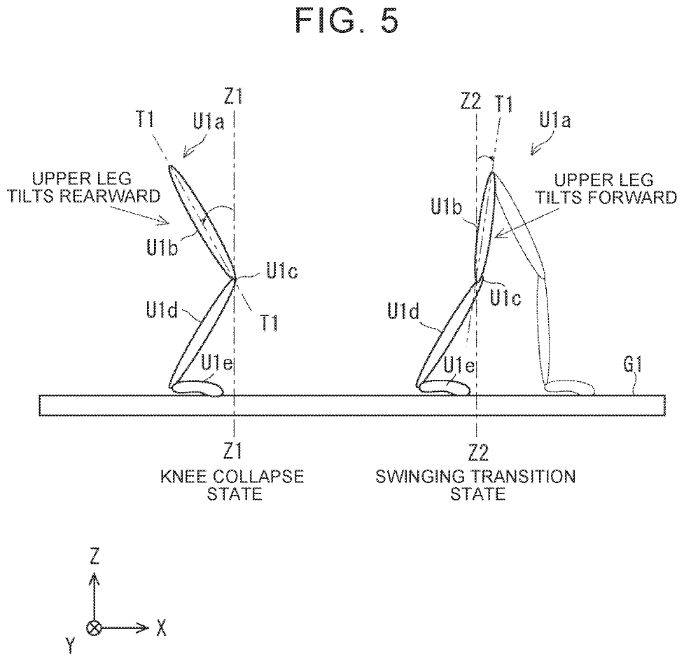

Specifically, as shown in FIG. 5, the upper leg U1b tilts rearward of the knee joint U1c in the knee collapse state. In other words, the knee joint U1c is located forward of the waist portion U1a (here, the positive side in the X-axis direction) during the standing phase. The knee collapse sensing unit 51b senses the knee collapse by detecting that the knee joint U1c is located forward of the waist portion U1a during the standing phase.

Further, in the swinging transition state in which the transition from the standing phase to the swinging phase is made, the upper leg U1b tilts forward of the knee joint U1c. In other words, the knee joint U1c is located rearward of the waist portion U1a (here, the negative side in the X-axis direction) during the standing phase. When the knee collapse sensing unit detects that the knee joint U1c is located rearward of the waist portion U1a during the standing phase, the knee collapse sensing unit 51b senses that the state is in the swinging transition state in which the transition from the standing phase to the swinging phase is made.

More specifically, the knee collapse sensing unit 51b determines whether the knee joint U1c of the user U1 is located forward of the waist portion U1a of the user U1 during the standing phase based on the upper leg posture angle θt. When the upper leg posture angle t is equal to or less than the upper leg swinging determination threshold value ThSw_t, the knee collapse sensing unit 51b determines that the knee joint U1c of the user U1 is located forward of the waist portion U1a of the user U1 during the standing phase, and senses the knee collapse. When the upper leg posture angle θt is equal to or more than the upper leg swinging determination threshold value ThSw_t, the knee collapse sensing unit 51b determines that the knee joint U1c of the user U1 is located rearward of the waist portion U1a of the user U1 during the standing phase, and does not sense the knee collapse. The upper leg swinging determination threshold value ThSw_t according to the present embodiment is 0 (zero), but the upper leg swinging determination threshold value ThSw_t may be set as appropriate, for example, and may be set according to the gait of the user U1.

When a sensor capable of detecting the position of the waist portion U1a with respect to the knee joint U1c is used for the upper leg posture angle acquisition unit 3, the knee collapse sensing unit 51b may sense the knee collapse based on the position of the waist portion U1a of the user U1 with respect to the knee joint U1c of the user U1. For example, when the upper leg posture angle acquisition unit 3 detects that the knee joint U1c of the user U1 is located forward of the waist portion U1a of the user U1 during the standing phase, the knee collapse sensing unit 51b senses the knee collapse.

The auxiliary force control unit 51c adjusts the resistance force applied by the actuator 6 to the rotation of the upper leg side link 1 and the lower leg side link 2.

When the walking state determination unit S1a determines that the walking state of the user U1 transitions from the standing phase to the swinging phase, the auxiliary force control unit S1c decreases the resistance force applied to the movement of the knee joint U1c of the user U1. Specifically, when the knee collapse sensing unit 51b senses the knee collapse, the auxiliary force control unit 51c reduces the degree of a decrease in the resistance force or maintains the resistance force.

In other words, the auxiliary force control unit 51c changes the resistance force applied by the actuator 6 according to the walking state of the user U1. The control state of the resistance force controlled by the auxiliary force control unit 51c includes an auxiliary phase and a free phase.

The auxiliary phase may be started in the middle of the swinging phase or at the time of transition from the swinging phase to the standing phase, and be ended at the time of transition from the standing phase to the swinging phase. When the auxiliary phase is stared from the middle of the swinging phase, the resistance force applied by the actuator 6 can be secured at the time of transition from the swinging phase to the standing phase, and it is possible to reliably assist the walking motion of the user U1. The free phase may be started at the time of transition from the standing phase to the swinging phase, and be ended in the middle of the swinging phase or at the time of transition from the swinging phase to the standing phase.

The auxiliary force control unit 51c sets the resistance force applied by the actuator 6 to a predetermined value in the auxiliary phase. This is intended to appropriately assist the walking motion of the user U1 in order to mainly correspond to the standing phase of the walking state of the user U1.

The auxiliary force control unit 51c may set the resistance force applied by the actuator 6 to a value lower than the above predetermined value or to 0 (zero) in the free phase. This is intended to weaken the assistance to the walking motion of the user U1 or to stop the assistance in order to mainly correspond to the swinging phase of the walking state of the user U1.

The memory 52 records a predetermined program. The arithmetic device 51 reads and executes this program, and functions as the walking state determination unit 51a, the knee collapse sensing unit 51b, and the auxiliary force control unit 51c.

The control unit 5 includes a hardware configuration centered on a microcomputer including a central processing unit (CPU), a read-only memory (ROM), a random-access memory (RAM), an interface (I/F), and the like. The CPU, ROM, RAM and the I/F are connected to each other via a data bus or the like.

The actuator 6 applies the resistance force to the rotation of the upper leg side link 1 and the lower leg side link 2 based on the control signal received from the control unit 5. The actuator 6 is, for example, a fluid cylinder or the like.

### Control Method

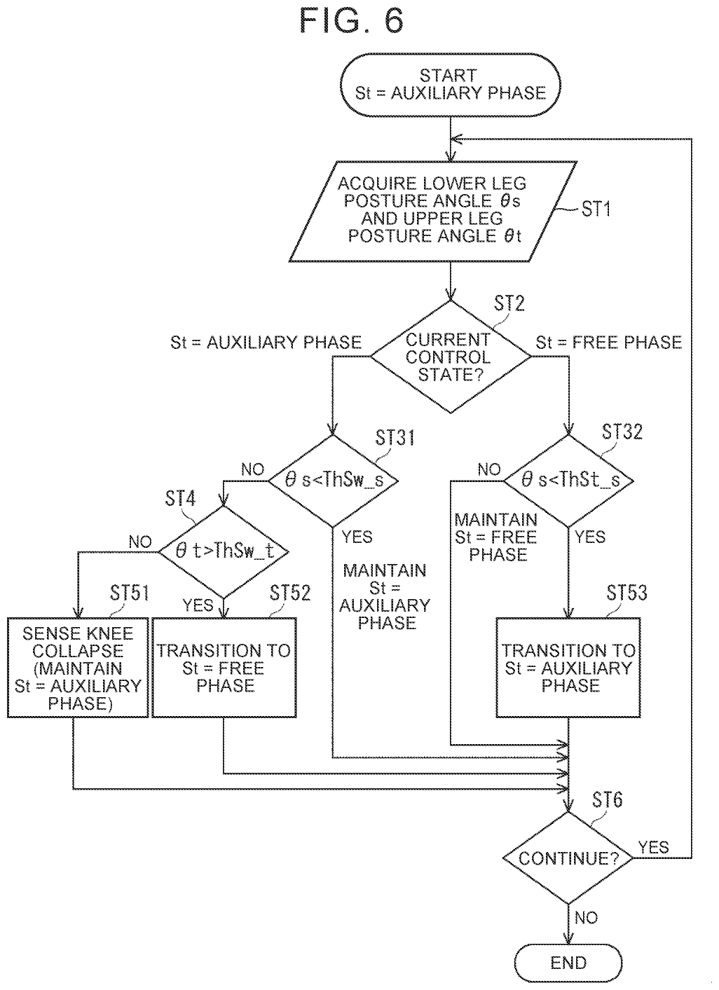

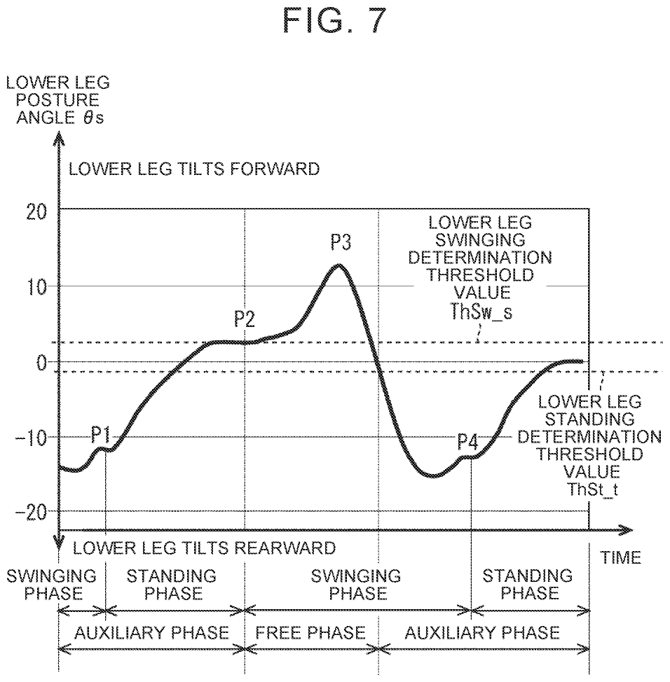

Next, a control method of the walking assist device according to the first embodiment will be described with reference to FIGS. 6 and 7. FIG. 6 is a flowchart of the control method of the walking assist device according to the first embodiment.

FIG. 7 is a graph showing a change in the lower leg posture angle θs in an example of the walking motion of the user.

At the time when the control of the walking assist device 10 is started, the control state is set to the auxiliary phase. The lower leg posture angle θs and upper leg posture angle θt at the current time are acquired (step ST1). Subsequently, the control state at the current time is confirmed (step ST2).

When the control state at the current time is in the auxiliary phase (step ST2: auxiliary phase), the magnitudes of the lower leg posture angle θs and the lower leg swinging determination threshold value ThSw_s are compared (step ST31).

When the lower leg posture angle θs is less than the lower leg swinging determination threshold value ThSw_s (step ST31: YES), it is determined that the walking state is in the standing phase, and the state in which the control state is in the auxiliary phase is maintained. Further, the process proceeds to step ST6.

On the other hand, when the lower leg posture angle θs is equal to or more than the lower leg swinging determination threshold value ThSw_s (step ST31: NO), the magnitudes of the upper leg posture angle θt and the upper leg swinging determination threshold value ThSw_t are compared (step ST4).

When the upper leg posture angle θt is equal to or less than the upper leg swinging determination threshold value ThSw_t (step ST4: NO), it is determined that the walking state is in the standing phase and the knee collapses, and the state in which the control state is in the auxiliary phase is maintained (step ST51). Further, the process proceeds to step ST6.

On the other hand, when the upper leg posture angle θt exceeds the upper leg swinging determination threshold value ThSw_t (step ST4: YES), it is determined that the walking state has transitioned from the standing phase to the swinging phase, and the control state transitions from the auxiliary phase to the free phase (step ST52). Further, the process proceeds to step ST6.

On the other hand, when the control state at the current time is in the free phase (step ST2: free phase), the magnitudes of the lower leg posture angle θs and the lower leg standing determination threshold value ThSt_s are compared (step ST32).

When the lower leg posture angle θs is less than the lower leg standing determination threshold value ThSt_s (step ST32: YES), it is determined that the walking state has transitioned from the swinging phase to the standing phase or is close to the standing phase, and the control state transitions from the free phase to the auxiliary period (step ST53). Further, the process proceeds to step ST6.

When the lower leg posture angle θs is equal to or more than the lower leg standing determination threshold value ThSt_s (step ST32: NO), it is determined that the walking state is in the swinging phase, and the state in which the control state is in the free phase is maintained. Further, the process proceeds to step ST6.

Finally, it is confirmed whether the control of the walking assist device 10 is continued (step ST6). That is, the steps ST1, ST2, ST31, ST32, ST4, ST51, ST52, and ST53 described above are repeated until the continuation of the control of the walking assist device 10 is stopped (step ST6: NO).

Here, an example of control by the walking assist device 10 at predetermined time points P1, P2, P3, and P4 during the walking motion of the user U1 shown in FIGS. 4 and 7 will be described.

At the time point P1, after the lower leg posture angle θs and the upper leg posture angle θt are acquired (step ST1), the control state is in the auxiliary phase (step ST2: auxiliary phase), and the lower leg posture angle θs is less than the lower leg swinging determination threshold value ThSw_s (step ST31: YES). Therefore, the control state remains in the auxiliary phase. At the time point P4, the control state of the walking assist device 10 remains in the auxiliary phase as in the time point P1.

At the time point P2, after the lower leg posture angle θs and the upper leg posture angle θt are acquired (step ST1), the control state is in the auxiliary phase (step ST2: auxiliary phase), and the lower leg posture angle θs is equal to or more than the lower leg swinging determination threshold value ThSw_s (step ST31: NO). When the upper leg posture angle θt exceeds the upper leg swinging determination threshold value ThSw_t (step ST4: YES), it is determined that the knee does not collapse, and the walking state transitions from the auxiliary phase to the free phase (step ST52). On the other hand, when the upper leg posture angle θt is equal to or less than the upper leg swinging determination threshold value ThSw_t (step ST4: NO), it is determined that the walking state is in the knee collapse state, and the control state remains in the auxiliary phase (step ST51).

At the time point P3, after the lower leg posture angle θs and the upper leg posture angle θt are acquired (step ST1), the control state is in the free phase (step ST2: free phase), and when the lower leg posture angle θs is equal to or more than the lower leg standing determination threshold value ThSt_s (step ST32: NO), the control state remains in the free phase.

From the above, it is possible to sense the knee collapse in the walking motion of the user U1. Therefore, the walking motion of the user U1 can be appropriately assisted.

### OTHER EMBODIMENTS

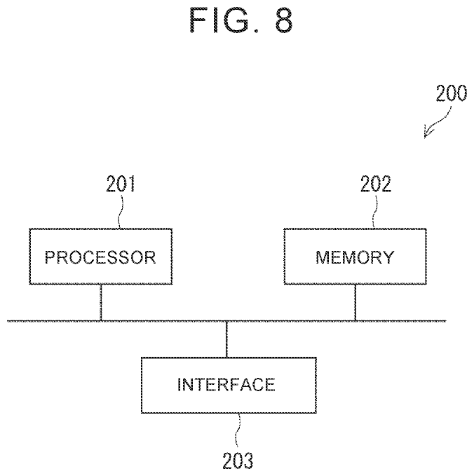

The walking assist device according to the above embodiment can be provided with the following hardware configuration. FIG. 8 is a diagram showing an example of a hardware configuration included in the walking assist device. As the procedure of processing in the walking assist device has been described in various embodiments described above, the present disclosure may also take the form of a processing method.

A walking assist device 200 shown in FIG. 8 includes a processor 201 and a memory 202 together with an interface 203. A control configuration of the walking assist device 10 (see FIG. 2) described in the above embodiment is realized in a manner such that the processor 201 reads and executes a control program stored in the memory 202. That is, this program is a program for causing the processor 201 to function as the walking assist device 10 or a part thereof.

The program includes instructions (or software codes) for causing the computer to perform one or more of the functions described in the embodiments when loaded into the computer. The program may be stored in a non-transitory computer-readable medium or a tangible storage medium. Examples of the computer-readable medium or the tangible storage medium include, but not limited to, a random-access memory (RAM), a read-only memory (ROM), a flash memory, a solid-stated rive (SSD) or other memory technologies, a compact disc read-only memory (CD-ROM), a digital versatile disc (DVD), a Blu-ray (registered trademark) disc, or other optical disc storages, a magnetic cassette, a magnetic tape, a magnetic disc storage, or other magnetic storage devices. The program may be transmitted on a transitory computer-readable medium or a communication medium. Examples of the transitory computer-readable medium or the communication medium include, but not limited to, electrical, optical, acoustic, or other forms of propagating signals.

The present disclosure is not limited to the above embodiments, and can be appropriately modified without departing from the spirit. Further, the present disclosure may be carried out by appropriately combining the above embodiments and examples thereof.

For example, the walking assist device 10 may further include a knee angle sensor. The knee angle sensor detects the knee angle θc in the knee joint U1c of the user U1. As shown in FIG. 3, the knee angle θc is, for example, an angle made by intersecting the longitudinal axis T1 of the upper leg U1b and the longitudinal axis T2 of the lower leg U1d. The walking assist device 10 may calculate the lower leg posture angle s by using the upper leg posture angle θt and the knee angle θc. Further, the walking assist device 10 may calculate the upper leg posture angle θt by using the lower leg posture angle θs and the knee angle θc.

Further, the walking assist device 10 may include a sole load sensor, a floor reaction force meter, a joint angle sensor, and the like. The walking assist device 10 may estimate the walking state based on data detected by each of the sole load sensor, the floor reaction force meter, and the joint angle sensor.

What is claimed is:

1. A walking assist device that applies resistance force to a movement of a knee joint of a user according to a walking state of the user to assist a walking motion of the user, the walking assist device comprising:
an auxiliary force control unit that decreases the resistance force applied to the movement of the knee joint of the user when determination is made that the walking state of the user transitions from a standing phase to a swinging phase; and
a knee collapse sensing unit that senses a knee collapse by detecting that the knee joint of the user is located forward of a waist portion of the user during the standing phase, wherein when the knee collapse sensing unit senses the knee collapse, the auxiliary force control unit reduces a degree of a decrease in the resistance force or stops the decrease in the resistance force.

2. The walking assist device according to claim 1, further comprising an upper leg posture angle acquisition unit that acquires an upper leg posture angle made by a longitudinal axis of an upper leg of the user and a vertical line, wherein the knee collapse sensing unit determines that the knee joint of the user is located forward of the waist portion of the user during the standing phase based on the acquired upper leg posture angle.

3. The walking assist device according to claim 1, further comprising a knee position sensor that is able to detect a position of the waist portion with respect to the knee joint of the user, wherein the knee collapse sensing unit determines that the knee joint of the user is located forward of the waist portion of the user during the standing phase using the knee position sensor.

4. A control method of a walking assist device, the control method being executed in the walking assist device that applies resistance force to a movement of a knee joint of a user according to a walking state of the user to assist a walking motion of the user, the control method comprising:
a step of decreasing the resistance force applied to the movement of the knee joint of the user when determination is made that the walking state of the user transitions from a standing phase to a swinging phase; and
a step pf sensing a knee collapse by detecting that the knee joint of the user is located forward of a waist portion of the user during the standing phase, wherein when the knee collapse is sensed in the step of sensing the knee collapse, a degree of a decrease in the resistance force is reduced or the decrease in the resistance force is stopped in the step of decreasing the resistance force.

5. A non-transitory storage medium storing a control program of a walking assist device, the control program being executed by a computer that operates as an arithmetic device in the walking assist device that applies resistance force to a movement of a knee joint of a user according to a walking state of the user to assist a walking motion of the user, the control program causing the computer to execute:
a step of decreasing the resistance force applied to the movement of the knee joint of the user when determination is made that the walking state of the user transitions from a standing phase to a swinging phase; and
a step pf sensing a knee collapse by detecting that the knee joint of the user is located forward of a waist portion of the user during the standing phase, wherein when the knee collapse is sensed in the step of sensing the knee collapse, the control program causes the computer to execute reducing a degree of a decrease in the resistance force or stopping the decrease in the resistance force in the step of decreasing the resistance force.
